(19) United States
(12) Patent Application Publication
(10) Pub. No.: US 2020/0192548 A1
(43) Pub. Date: Jun. 18, 2020

(54) METHODS AND APPARATUS FOR DISPLAYING A CURSOR ON A HIGH DYNAMIC RANGE DISPLAY DEVICE

(71) Applicant: ATI Technologies ULC, Markham (CA)

(72) Inventor: DAVID I.J. GLEN, Toronoto (CA)

(21) Appl. No.: 16/218,592

(22) Filed: Dec. 13, 2018

(51) Int. Cl. G06F 3/0481; G09G 5/30; G09G 5/02; G09G 5/10

(52) U.S. Cl. CPC G06F 3/04812; G09G 5/30; G09G 5/02; G09G 2320/02; G09G 2340/06; G09G 2360/142; G09G 5/10

(57) ABSTRACT

Methods and apparatus for displaying a cursor on a high dynamic range (HDR) display device are presented. In some variations, the methods and apparatus obtains a reference luminance level indicating a default white value for the HDR display device. The method and apparatus adjusts a luminance level associated with the cursor on the HDR display device to be greater than the reference luminance level. The method and apparatus causes display of the cursor at the adjusted luminance level on the HDR display device.

### BACKGROUND OF THE DISCLOSURE

A cursor, such as a cursor icon, is typically used for pointing to a pictorial representation on a display device to show a current position of user interaction. For example, a pointing device, such as a mouse, is connected to a computer system that displays a cursor icon (e.g., cursor) on the display device. The cursor icon may be a bitmap image or mask in the form of an arrow, which appears to freely float across the display device in response to user input signals generated by the pointing device. Sometimes, a user may have difficulty finding the cursor icon on the display device due to the cursor's size or color blending in with surrounding areas of the display device. Conventional techniques for quickly locating the cursor icon may include a temporary enlargement of the cursor icon or a highlighted circle around the cursor icon.

Furthermore, with the introduction of HDR display devices, finding the location of the cursor icon has become even more difficult. For example, HDR display devices may show brighter images and/or movies than standard dynamic range (SDR) display devices. For instance, SDR display devices may have a dynamic luminance range (e.g., brightness level) from 0.1 to 100 nits. However, HDR display devices may have a dynamic luminance range from 0 to 2,000 nits. As such, controls have been introduced to set the color or luminance level of the cursor at a reference luminance or white level (e.g., 200 nits), which is lower than the maximum brightness of the display. This may be performed to first ensure that the display device is not so bright as to be uncomfortable, but also because many HDR display devices cannot have more than about 10% of the pixels on the display reach the maximum brightness due to power and heat limitations. However, the user may still have difficulty locating the cursor at the reference luminance level, especially as HDR display sizes, increase or as additional HDR displays have been included to the computer system. Accordingly, there exists a need for improved methods and apparatus for displaying the cursor on the HDR display device in order to address one or more of the above-noted drawbacks.

### BRIEF DESCRIPTION OF THE DRAWINGS

The variations will be more readily understood in view of the following description when accompanied by the below figures and wherein like reference numerals represent like elements, wherein:

FIG. 1 is a block diagram illustrating one example of an apparatus for displaying a cursor on a high dynamic range (HDR) display device in accordance with one embodiment set forth in the disclosure;

FIG. 2 is a block diagram illustrating exemplary logic of the apparatus shown in FIG. 1;

FIG. 3 is a flowchart illustrating one example of a method for displaying the cursor on the HDR display device in accordance with one embodiment set forth in the disclosure;

FIG. 4 is a flowchart illustrating one example of the method for adjusting a luminance level of the cursor in accordance with one embodiment set forth in the disclosure; and

FIG. 5 is a flowchart illustrating one example of the method for detecting a triggering event performed for the HDR display device in accordance with one embodiment set forth in the disclosure.

### DETAILED DESCRIPTION OF EMBODIMENTS

Briefly, in one example, methods and apparatus provide an adjustment control of a luminance level of a cursor displayed on a high dynamic range (HDR) display device. For example, the method and apparatus obtains, using logic, a reference luminance level indicating a default white value for the HDR display device. For example, the HDR display device initially displays a cursor at a certain brightness level (e.g., the reference luminance level). However, due to the cursor size and/or brightness, a user might not be able to identify the location of the cursor. As such, the method and apparatus adjusts the luminance level associated with the cursor that is displayed on the HDR display device to be greater than the reference luminance level. For instance, if a reference luminance level (e.g., initial brightness of the cursor) is at 200 nits, then the method and apparatus adjusts the luminance level to a value greater than the reference luminance level. After, the method and apparatus causes display of and/or displays the cursor at the adjusted luminance level (e.g., 500 nits) on the HDR display device.

In some variations, the method and apparatus adjusts the luminance level to be less than or equal to a peak luminance level. For example, the peak luminance level is a maximum brightness level that is able to be displayed on the HDR display device, and the adjusted luminance level is less than or equal to this level. In some variations, the method and apparatus increases the luminance level of the cursor to the adjusted luminance level for a set period of time, such as for three seconds. In some variations, the method and apparatus increase the luminance level of the cursor by increasing luminance level of the cursor by a set percentage higher than the reference luminance level.

In some variations, the method and apparatus increases the luminance level of the cursor to the adjusted luminance level in response to a first triggering event. In some instances, the method and apparatus decreases the luminance level of the cursor from the adjusted luminance level to a second adjusted luminance level in response to a second triggering event. The second adjusted luminance level is less than the adjusted luminance level. The method and apparatus causes display of the cursor at the second adjusted luminance level of the HDR display device. In some examples, the first triggering event is a user command indicating a request to locate the cursor on the HDR display device. For example, the first triggering event is a user moving a mouse, a user selection on an HDR touch screen, and/or a triggering key. In some examples, the second triggering event is a user command indicating a request to stop locating the cursor on the HDR display device.

In some variations, the method and apparatus assigns a triggering key on an input/output device. The method and apparatus adjusts the luminance level associated with the cursor on the HDR display device based on detecting an activation of the triggering key on the input/output device. In some variations, the method and apparatus adjusts the luminance level associated with the cursor on the HDR display device in response to obtaining user input from a pointing device.

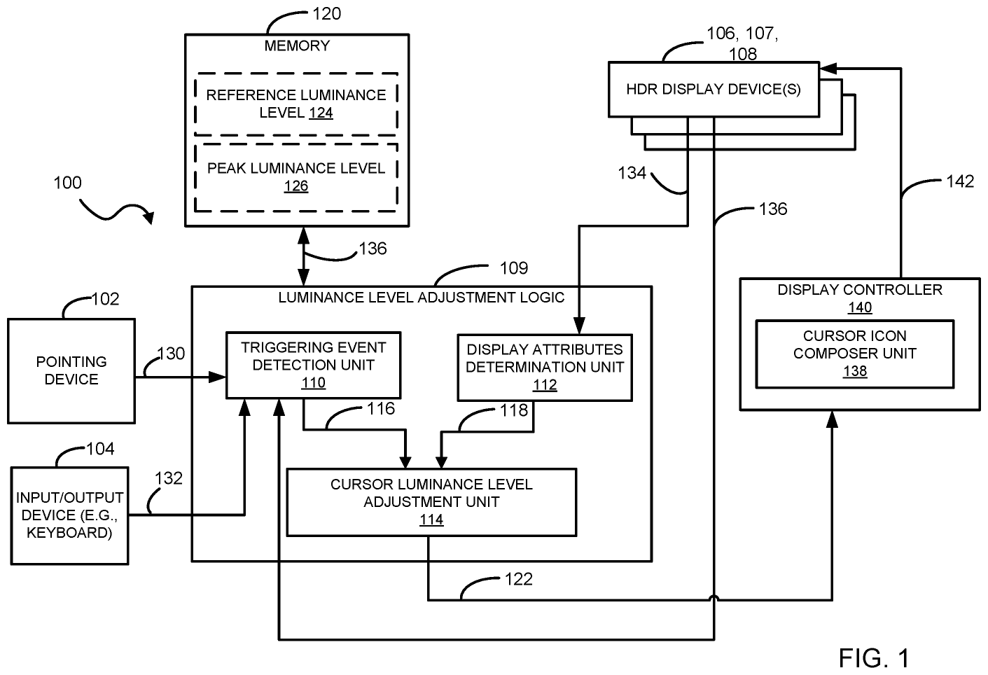

FIG. 1 illustrates one example of an apparatus 100 for displaying the cursor on the HDR display device in accordance with variations of the disclosure. The apparatus 100 includes any type of electronic device suitable for implementing aspects of variations of the disclosed subject matter. Examples of electronic devices include but are not limited to workstations, laptops, desktops, tablet computers, hand-held devices, game consoles, monitors, and the like, all of which are contemplated within the scope of FIG. 1, with reference to various components of the system 100 and/or apparatus 100.

In some variations, the apparatus 100 includes a pointing device 102, an input/output device 104 (e.g., keyboard), one or more HDR display devices 106, 107, 108, a display controller 140, and luminance level adjustment logic 109 (e.g., logic). Any number of components, different components, and/or combinations of components is included in the apparatus 100. For instance, while apparatus 100 only shows three HDR display devices 106, 107, 108, in some variations, apparatus 100 includes more or less than three HDR display devices. Further, in some examples, the input/output device 104 includes a microphone, a joystick, a wireless device, a keyboard, a pen, a voice input device, and a touch input device, a touch-screen device, an interactive display device, a mouse, and/or the like. In some instances, the pointing device 102 is a mouse, light pen, touch screen (e.g., the pointing device 102 and the HDR display device 106 are the same device), trackpad, and/or camera. The pointing device 102 obtains user input, such as a user gesture, and provides the user input/gesture to the luminance level adjustment logic 109. For example, the pointing device 102 is a mouse, trackpad, light pen, and/or touch screen. The pointing device 102 detects a gesture of the user (e.g., captures user input), and provides the gesture to the logic 109. Additionally, and/or alternatively, the pointing device 102 is a camera that is configured to detect a gesture, such as a movement of the user, and provide the detected gesture to the logic 109.

In some instances, the display controller 140 drives (e.g., generates) one or more images to be displayed on one or more of the HDR display devices 106, 107, 108. Further, the display controller 140 includes one or more units, such as a cursor icon composer unit 138, to generate portions of the image. For example, the cursor icon composer unit 138 generates a cursor to be displayed on the HDR display devices 106, 107, 108. As will be explained in further detail below, the cursor icon composer unit 138 obtains an instruction (e.g., instruction 122) from the logic 109 and uses the instruction 122 to set the luminance level for a cursor to be displayed on the HDR display devices 106, 107, 108. After generating the image, including the cursor, the display controller 140 provides the image 142 to the HDR display device 106, 107, 108. In some examples, the logic 109 is included within the display controller 140 and/or the cursor icon composer unit 138. For example, one or more units of the logic 109 is included within the cursor icon composer unit 138.

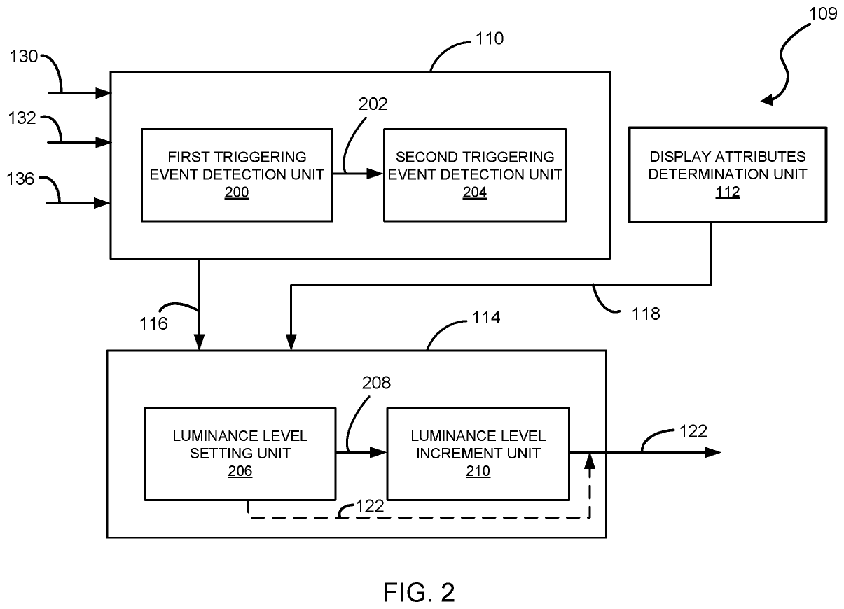

In some variations, the logic 109 is any suitable logic configuration including, but not limited to, one or more state machines, one or more digital signal processors, GPUs, APUs, CPUs, or processors that execute kernels, and/or other suitable structure as desired. The logic 109 includes a triggering event detection unit 110 configured to detect a triggering event. For example, the triggering event detection unit 110 obtains information indicating a triggering event from the pointing device 102, the input/output device 104, and/or an HDR display device, such as the HDR display devices 106. Also, the logic 109 includes a display attributes determination unit 112 configured to obtain one or more display attributes, such as a peak luminance level and a reference luminance level (e.g., reference white level), from the HDR display devices 106, 107, 108. Further, the logic 109 includes a cursor luminance level adjustment unit 114 configured to adjust the luminance level associated with the cursor on the HDR display device. For example, based on the reference luminance level, the cursor luminance level adjustment unit 114 adjusts the luminance level of the cursor. Additional descriptions of apparatus 100, including the logic 109, are provided below in paragraphs relating to FIGS. 2-5.

Although the units 110, 112, and 114 are illustratively depicted as separate units, the functions and capabilities of each unit can be implemented, combined, and used in conjunction with/into any unit or any combination of units to suit different applications. In one example, the logic 109, including the units 110, 112, and/or 114, resides in one or more processors and/or processor cores for executing instructions. In some variations, the apparatus 100 includes a number of processors, a number of pointing devices, a number of input/output devices, a number of HDR display devices and the like to suit the application. Additionally, any number of these components, or combinations thereof, are distributed and/or duplicated across a number of electronic devices.

Variations of the present disclosure are described below by way of example only, with reference to the accompanying drawings. Further, the following description is merely exemplary in nature and is in no way intended to limit the disclosure, its application, or uses. As used herein, the term “unit” refers to, be part of, or include an Application Specific Integrated Circuit (ASIC), an electronic circuit, a processor or microprocessor (shared, dedicated, or group) or portion thereof and/or memory (shared, dedicated, or group) that executes one or more software or firmware programs, a combinational logic circuit, and/or other suitable components that provide the described functionality. Other implementation techniques are equally employed, such as programmable logic arrays and state machines. Thus, while this disclosure includes particular examples and arrangements of the units, the scope of the present system should not be so limited since other modifications will become apparent to the skilled practitioner.

More specifically, the triggering event detection unit 110 is configured to obtain (e.g., retrieve and/or receive) a triggering event initiated the pointing device 102, the input/output device 104, and/or an HDR display device (e.g., the HDR display device 106, 107, and/or 108). In some examples, the pointing device 102 detects user input, such as a user manipulating a current position of a cursor. For example, when a user moves or activates the pointing device 102, the pointing device 102 provides (e.g., transmits) information 130 indicating the user input to the triggering event detection unit 110. In other examples, the input/output device 104 detects user input, such as a user pressing a key on a keyboard, and provides information 132 indicating the user input to the triggering event detection unit 110. For example, the input/output device 104 is a keyboard assigned with a triggering key, such as the “ctrl” key on the keyboard. When the “ctrl” key is operated, depressed, or released after depression by the user, input/output device 104 provides the triggering key to the triggering event detection unit 110. For example, the input/output device 104 provides the triggering key in response to a release of the “ctrl” key after depression and when detecting that no other keys have been depressed during the depression of the “Ctrl key.” In yet other examples, at least one of the HDR display devices (e.g., the HDR display device 106) is a touchscreen. The HDR display device 106 detects user input, such as a user using the touch screen capabilities, and provides the user input to the triggering event detection unit 110.

The display attributes determination unit 112 is configured to obtain one or more display attributes 134 from one or more of sources, such as the HDR display devices 106, 107, 108. The display attributes 134 include a reference luminance level 124 and/or a peak luminance level 126 for one or more of the HDR display devices 106, 107, 108. The HDR display devices 106, 107, and/or 108 have different display attributes 134 (e.g., reference luminance levels 124 and/or peak luminance levels 126) from standard definition range (SDR) display devices. For example, HDR movies and/or images have a brightness range or a dynamic luminance range of 0 to 10,000 nits. However, some HDR display devices might not be able to display a brightness of 10,000 nits. Instead, these HDR display devices have a dynamic luminance range less than the entire range (e.g., from 0 to 2,000 nits). Furthermore, in some examples, different HDR display devices, such as the HDR display device 106 and 107, also displays different dynamic luminance ranges. In some variations, the display attributes 134 for each of the HDR display device 106, 107, 108 are the same. In other variations, the display attributes 134 for the HDR display devices 106, 107, and 108 are different.

The peak luminance level 126 refers to a maximum luminance value (e.g., brightness value) for the corresponding HDR display device 106, 107, 108. For example, if the HDR display device 106 has a luminance range from 0 to 2,000 nits, then the maximum luminance value is 2,000 nits. In some examples, the user sets the peak luminance level 126. For example, the logic 109 presents and/or causes display of a prompt on a display device, such as the HDR display device(s) 106, 107, and/or 108. The user uses the prompt, such as a slide bar, to set the peak luminance level 126. The logic 109 obtains the user input indicating the peak luminance level 126, and stores the peak luminance level 126 in memory 120. Additionally, and/or alternatively, the apparatus 100 executes an operating system (OS), and based on executing the operating system, the apparatus 100 determines the peak luminance level 126. In some instances, the OS determined peak luminance level 126 is the same as the peak luminance level from the HDR display device 106, 107, and/or 108 and/or the user set peak luminance level 126. In other instances, the OS determined peak luminance level 126 is different from the user set peak luminance level 126 and/or the peak luminance level 126 of the HDR display device.

The reference luminance level 124 refers to a reference or default luminance value. In some examples, the reference luminance level 124 represents a default white or target paper white level (e.g., a luminance value used to display a sheet of white paper or white background). For example, the HDR display device 106 has a reference luminance level 124 of 200 nits.

In some examples, the HDR display devices 106, 107, 108 provides the display attributes 134 (e.g., the reference luminance level 124 and the peak luminance level 126) in the form of an Extended Display Identification Data (EDID)/Enhanced EDID (E-DID) structure. Other suitable structures, such as DisplayID, can be employed to suit different applications. In some variations, the input/output device 104 and/or the pointing device 102 provides the reference luminance level 124 and/or the peak luminance level 126. For example, a user, using the input/output device 104 and/or the pointing device 102, inputs the reference luminance level 124 and the peak luminance level 126.

In some variations, after obtaining the display attributes 134, the display attributes determination unit 112 stores information 136, such as the reference luminance level 124 and the peak luminance level 126, in memory 120. Depending on the application (e.g., the location of the cursor on the HDR display device), the display attributes determination unit 112 determines which display attributes to use for the operation. For example, if the cursor is on the HDR display device 106, the display attributes determination unit 112 obtains the reference luminance level 124 and/or the peak luminance level 126 for the HDR display device 106. Additionally, and/or alternatively, if the cursor is on the HDR display device 107, the display attributes determination unit 112 obtains the reference luminance level 124 and/or the peak luminance level 126 for the HDR display device 107.

In some variations, the memory 120 included in the apparatus 100 has computer-readable media in the form of volatile and/or nonvolatile memory and is removable, nonremovable, or a combination thereof. Media examples include Random Access Memory (RAM); Read Only Memory (ROM), Electronically Erasable Programmable Read Only Memory (EEPROM), flash memory, optical or holographic media, magnetic storage devices, and/or any other medium that can be used to store information and can be accessed by an electronic device such as, for example, quantum state memory, and/or the like. A distributed memory system shared in one or more servers (e.g., web servers or non-web servers) is also contemplated to suit different applications.

In some variations, other display attributes for the HDR display devices 106, 107, 108 are also be received. For example, the display attributes include other content delivery information (e.g., 3840×2160, 7680×4320, or 1920×1080 pixel resolution), such as a connection speed, an image size, a maximum visible display size, a maximum display resolution, a picture aspect ratio, and the like. In one example, the content delivery information is stored in a look-up table in the memory 120, or received in the EDID or DisplayID form. In another example, each display 106, 107, 108 provides at least some of the display configuration or content delivery information (e.g., the display resolution) in the EDID or DisplayID form, which is stored as a read-only memory (ROM) during manufacturing. Those having skill in the art will appreciate that other techniques for obtaining the display attributes are equally employed.

The cursor luminance level adjustment unit 114 is configured to adjust the luminance level associated with the cursor on the HDR display device 106, 107, and/or 108 based on the reference luminance level 124 and/or the peak luminance level 126. Further, the cursor luminance level adjustment unit 114 is configured to cause display of the cursor on the HDR display device 106, 107, and/or 108. For example, the cursor luminance level adjustment unit 114 is communicably connected to the triggering event detection unit 110 and the display attributes determination unit 112. For example, when the triggering event is detected, the triggering event detection unit 110 provides information 116, such as the detected triggering event, to the cursor luminance level adjustment unit 114. Additionally, and/or alternatively, when the display attributes determination unit 112 obtains the reference luminance level 124 and/or the peak luminance level 126, the display attributes determination unit 112 provides this information 118 to the cursor luminance level adjustment unit 114.

The cursor luminance level adjustment unit 114 is configured to cause display of the cursor at an adjusted luminance level on the HDR display device 106, 107 and/or 108. For example, the cursor luminance level adjustment unit 114 is configured to provide an instruction 122 to the display controller 140 (e.g., the cursor icon composer unit 138) to set the luminance level associated with the cursor on the HDR display device 106, 107, 108 to an adjusted luminance level that is greater than the reference luminance level 124 and less than the peak luminance level 126. For instance, if the reference luminance level 124 is 200 nits and the peak luminance level 126 is 2,000 nits, then the cursor luminance level adjustment unit 114 is configured to provide the instruction 122 to set the luminance level of the cursor to 500 nits.

In some variations, the cursor luminance level adjustment unit 114 does not obtain the peak luminance level 126, and the cursor luminance level adjustment unit 114 sets the luminance level of the cursor an adjusted luminance level that is greater than the reference luminance level 124 by a certain value regardless of the peak luminance level 126. In some examples, if the luminance level of the cursor is set to a value that is greater than the peak luminance level 126 (e.g., greater than 2,000 nits), the HDR display device 106, 107, 108 simply displays the cursor at the peak luminance level 126 (e.g., 2,000 nits).

In some examples, the cursor luminance level adjustment unit 114 is configured to provide an instruction 122 that temporarily increases the luminance level of the cursor by a percentage relative to a current luminance level of the cursor for a time period. For example, if the current luminance level (e.g., the reference luminance level 124) is at 200 nits, then the cursor luminance level adjustment unit 114 determines, based on a percentage (e.g., 100% increase) of the current luminance level (e.g., 200 nits), an adjusted luminance level (e.g., 400 nits). Then, the cursor luminance level adjustment unit 114 provides an instruction 122 to increase the luminance level of the cursor to 400 nits for a time period, such as for 5 seconds. In some variations, a user, using the pointing device 102 and/or the input/output device 104, sets the time period.

In some examples, the cursor luminance level adjustment unit 114 is configured to provide the instruction 122 that permanently increases the luminance level of the cursor to the adjusted luminance level (e.g., 500 nits) by a value when the first triggering event is detected. However, in some variations, the cursor luminance level adjustment unit 114 is configured to provide a second instruction that reduces the adjusted luminance level (e.g., 500 nits) to a second adjusted luminance level when a second triggering event is detected. The second adjusted luminance level is any luminance level below the adjusted luminance level (e.g., 500 nits). In some examples, the second adjusted luminance level is the reference luminance level (e.g., 200 nits).

For example, the second triggering event is a subsequent activation of the pointing device 102 after the pointing device 102 has been activated during the first triggering event. In some variations, the second triggering event is a subsequent operation of the “ctrl” key on the keyboard after the “ctrl” key has been depressed during the first triggering event. In some variations, other suitable second triggering events, such as movement of the pointing device 102 or voice activation with a keyword (e.g., “STOP”), are also contemplated to suit different applications. When the second triggering event is detected, the cursor luminance level adjustment unit 114 is configured to decrease the luminance level (e.g., 500 nits) of the cursor back to the previous luminance level (e.g., 200 nits). This is explained in further detail in FIG. 2. Further, in some examples, the second triggering event is an expiration of a timer. For example, the first triggering event (e.g., activating the “ctrl” key) begins a timer and the second triggering event is the expiration of the timer. In response to the second triggering event, the cursor luminance level adjustment unit 114 is configured to decrease the luminance level (e.g., 500 nits) of the cursor to a second adjusted luminance level.

In some examples, the cursor luminance level adjustment unit 114 is configured to provide the instruction 122 that gradually increases the luminance level of the cursor by a value when detecting a first triggering event (e.g., activation of the “ctrl” key). In response to detecting a second triggering event, the cursor luminance level adjustment unit 114 stops the increase of the luminance level of the cursor. For example, the logic 109 obtains a first triggering event indicating a user has activated the “ctrl” key (e.g., the user is attempting to find the location of the cursor on the HDR display device 106, 107 and/or 108). The logic 109 gradually increases the luminance level of the cursor by a value, such as by 20 nits. When the user finds the location of the cursor, the logic 109 obtains a second triggering event, (e.g., a second activation of the “ctrl” key).

FIG. 2 illustrates one example of the logic 109 of the apparatus 100 in accordance with variations of the disclosure. For example, the triggering event detection unit 110 includes a first triggering event detection unit 200 and a second triggering event detection unit 204. Further, the cursor luminance level adjustment unit 114 includes a luminance level setting unit 206 and a luminance level increment unit 210. Although the units 200, 204, 206, 210 are illustratively depicted as separate units, the functions and capabilities of each unit can be implemented, combined, and used in conjunction with/into any unit or any combination of units to suit different applications. For example, the units 200 and 204 can be combined together as a single unit. Other suitable arrangements are contemplated.

In particular, FIG. 2 illustrates an example of setting the cursor at a first luminance level in response to detecting a first triggering event, and setting the cursor at a second luminance level in response to detecting a second triggering event. For example, the first triggering event detection unit 200 is configured to detect the first triggering event as mentioned above. After the first triggering event detection unit 200 detects the first triggering event, the first triggering event detection unit 200 provides information indicating the detected first triggering event to the second triggering event detection unit 204.

Additionally, and/or alternatively, the first triggering event detection unit 200 provides the information 116 indicating the detected first triggering event to the cursor luminance level adjustment unit 114. The cursor luminance level adjustment unit 114 provides the instruction 122 that increases the luminance level of the cursor to the adjusted luminance level. In some examples, when the first triggering event is detected, the luminance level setting unit 206 is configured to set the luminance level associated with the cursor on the HDR display device 106, 107, 108 from the initial reference luminance level 124 (e.g., 200 nits) to the adjusted luminance level (e.g., 500). As mentioned above, the luminance level setting unit 206 adjusts the luminance level of the cursor to the adjusted luminance level by increasing the luminance level of the cursor by a set percentage higher than the reference luminance level 124. Further, the adjusted luminance level is greater than the reference luminance level 124 (e.g., 200 nits).

In some variations, the luminance level increment unit 210 is provided with the adjusted luminance level. When the first triggering event is detected, the luminance level increment unit 210 temporarily increases the luminance level of the cursor to the adjusted luminance level for a period of time. In other variations, the luminance level increment unit 210 is configured to permanently increase the luminance level of the cursor to the adjusted luminance level. In yet other variations, the luminance level setting unit 206 bypasses the luminance level increment unit 210 and provide the instruction 122 to the display controller 140.

The second triggering event detection unit 204 is configured to detect the second triggering event after the first triggering event. When the second triggering event is detected, the second triggering event detection unit 204 provides information 116 indicating an occurrence of the second triggering event to the cursor luminance level adjustment unit 114. In response to the second triggering event, the cursor luminance level adjustment unit 114 provides the instruction 122 that decreases the luminance level of the cursor by a certain value. For example, the cursor luminance level adjustment unit 114 adjusts the luminance level of the cursor from 500 nits (e.g., the adjusted luminance level) back to 300 nits. In some variations, the cursor luminance level adjustment unit 114 provides the instruction 122 that decreases the luminance level of the cursor to a second adjusted luminance level (e.g., a luminance level, such as 300 nits, that is below the adjusted luminance level, such as 500 nits). In some instances, the second adjusted luminance level is the initial default brightness value (e.g., the reference luminance level 124, 200 nits). In some variations, the luminance level setting unit 206 provides the instruction 122 that sets the luminance level of the cursor to a luminance level that is substantially equal to the initial default brightness value (e.g., 220 nits).

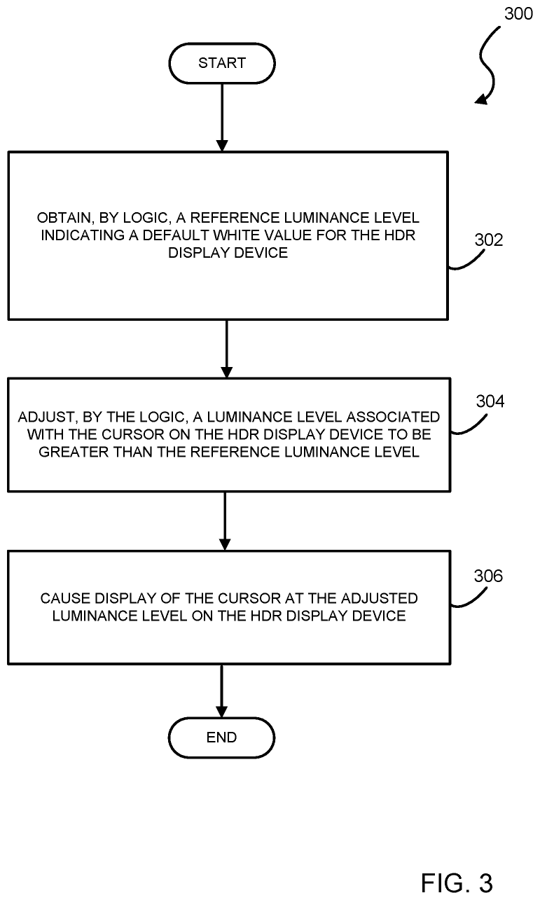

FIG. 3 illustrates one example of a method 300 for displaying the cursor on the HDR display device 106, 107, 108 in accordance with one embodiment set forth in the disclosure. FIG. 3 will be described with reference to FIGS. 1-2. However, any suitable structure can be employed.

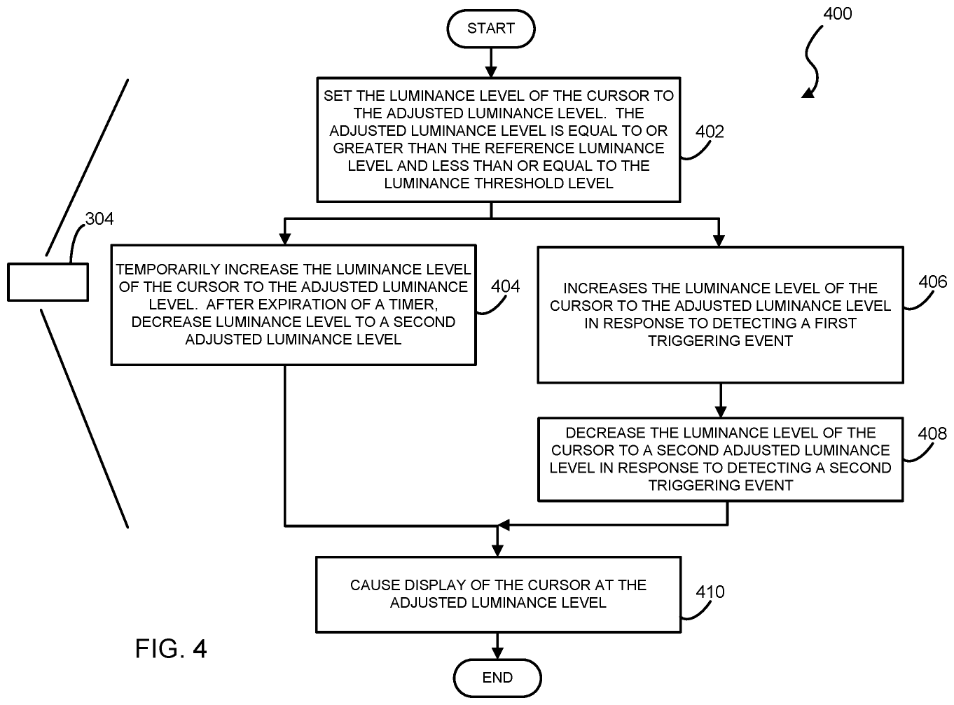

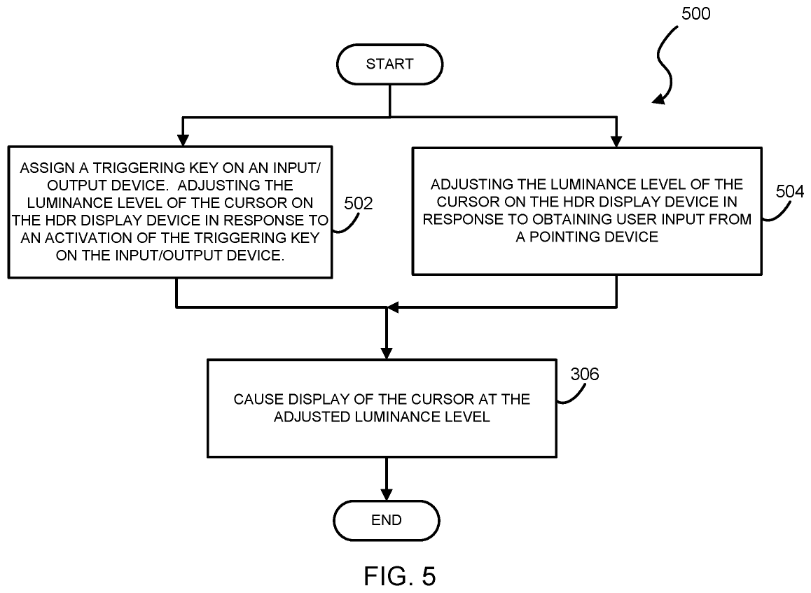

In operation, at block 302, the logic 109 obtains a reference luminance level indicating a default white value for the HDR display device. At block 304, the logic 109 adjusts a luminance level associated with the cursor on the HDR display device to be greater than the reference luminance level. At block 306, the logic 109 causes display of the cursor at an adjusted luminance level on the HDR display device. Block 304 is further illustrated in FIGS. 4 and 5.

FIG. 4 illustrates one example of a method 400 for performing block 304 of FIG. 3 in accordance with one embodiment set forth in the disclosure. It will be described with reference to FIGS. 1-3. However, any suitable structure can be employed. Although sub-blocks 402-410 are illustrated, other suitable sub-blocks can be employed to suit different applications.

In one embodiment, at block 402, the logic 109 provides the instruction 122 to set the luminance level of the cursor to the adjusted luminance level. The adjusted luminance level is equal to or greater than the reference luminance level and less than or equal to the peak luminance level. Depending on the application, control proceeds to either block 404 or 406.

At block 404, the logic 109 provides an instruction 122 that temporarily increases the luminance level of the cursor to the adjusted luminance level. For example, the logic 109 sets the luminance level of the cursor to the adjusted luminance level (e.g., 500 nits) for a period of time (e.g., 2-3 seconds). After the period of time expires (e.g., expiration of a timer), the logic 109 decreases the luminance level of the cursor from the adjusted luminance level (e.g., 500 nits) to a second adjusted luminance level (e.g., 300 nits).

At block 406, the logic 109 provides an instruction 122 that increases the luminance level of the cursor to the adjusted luminance level in response to detecting a first triggering event (e.g., a user attempting to detect a location of the cursor on the HDR display device 106, 107 and/or 108). The logic 109 causes display of the cursor at the adjusted luminance level. At block 408, the logic 109 provides an instruction 122 that decreases the luminance level of the cursor in response to detecting a second triggering event. For example, the luminance level of the cursor is reduced to a second adjusted luminance level (e.g., 300 nits) when the second triggering event is detected. In some examples, the second adjusted luminance level is the reference luminance level (e.g., 200 nits). At block 410, the logic 109 causes display of the cursor at the adjusted luminance level (e.g., the adjusted luminance level and/or the decreased luminance level back to the initial brightness value).

FIG. 5 illustrates one example of a method 500 for detecting the triggering event performed for the HDR display device 106, 107, 108 in accordance with one embodiment set forth in the disclosure. It will be described with reference to FIGS. 1-4. However, any suitable structure can be employed. Depending on the application, the logic 109 obtains the first triggering event from the pointing device, the input/output device, and/or the HDR display devices 106, 107, 108.

In some variations, at block 502, the logic 109 assigns a triggering key (e.g., “ctrl” key) on the input/output device 104 (e.g., keyboard). The logic 109 adjusts the luminance level associated with the cursor on the HDR display device in response to an activation of the triggering key on the input/output device. At block 504, the logic 109 adjusts the luminance level associated with the cursor on the HDR display device in response to obtaining user input from a pointing device, such as pointing device 102. In some variations, the user input includes shaking of the pointing device 102 (e.g., a user shaking or moving a mouse). At block 306, the logic 109 causes display of the cursor at the adjusted luminance level. In some instances, method 400 uses the triggering key for the input/output device 104 and/or the user input from the pointing device 102. In other words, the triggering key and/or the user input can be the first triggering event and/or the second triggering event as described in steps 406 and 408.

Among other advantages, as described above, the method and apparatus provides adjustment of the luminance level of the cursor upon the triggering event based on the reference luminance level of the HDR display device. As shown above, an automatic adjustment of the luminance level of the cursor is performed by the logic 109 for readily identifying an exact location of the cursor on the HDR display device. When the triggering event is initiated, the logic 109 automatically sets the luminance level of the cursor to the predetermined luminance level that is greater than the reference luminance level. Advantageously, the cursor is easily locatable by the user during operation.

The above detailed description of the present disclosure and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein.

1. A method for displaying a cursor on a high dynamic range (HDR) display device, comprising:
obtaining, by logic, a reference luminance level indicating a default white value for the HDR display device wherein the reference luminance level is less than a peak luminance level for the HDR display device;
adjusting, by the logic, a luminance level associated with the cursor on the HDR display device to be greater than the reference luminance level; and
causing display of the cursor at the adjusted luminance level on the HDR display device.

2. The method of claim 1, wherein the adjusted luminance level is less than the peak luminance level.

3. The method of claim 1, wherein the adjusting the luminance level comprises increasing the luminance level of the cursor to the adjusted luminance level for a set period of time.

4. The method of claim 3, wherein the adjusted luminance level is a set percentage higher than the reference luminance level.

5. The method of claim 1, wherein the adjusting the luminance level of the cursor comprises:
increasing the luminance level of the cursor to the adjusted luminance level in response to a first triggering event.

6. The method of claim 5, further comprising:
decreasing the luminance level of the cursor from the adjusted luminance level to a second adjusted luminance level in response to a second triggering event; and
causing display of the cursor at the second adjusted luminance level on the HDR display device.

7. The method of claim 6, wherein the first triggering event is a first user command indicating a request to locate the cursor on the HDR display device, and wherein the second triggering event is a second user command indicating a request to stop locating the cursor on the HDR display device.

8. The method of claim 1, further comprising:
assigning a triggering key on an input/output device,
wherein the adjusting the luminance level associated with the cursor on the HDR display device is in response to detecting an activation of the triggering key on the input/output device.

9. The method of claim 1, wherein the adjusting the luminance level associated with the cursor on the HDR display device is in response to obtaining user input from a pointing device.

10. A device comprising:
luminance level adjustment logic configured to:
obtain a reference luminance level indicating a default white value for a high dynamic range (HDR) display device wherein the reference luminance level is less than a peak luminance level for the HDR display device;
adjust a luminance level associated with a cursor on the HDR display device to be greater than the reference luminance level; and
cause display of the cursor at the adjusted luminance level on the HDR display device.

11. The device of claim 10, wherein the adjusted luminance level is less than the peak luminance level.

12. The device of claim 10, wherein the luminance level adjustment logic is configured to adjust the luminance level by increasing the luminance level of the cursor to the adjusted luminance level for a set period of time.

13. The device of claim 12, wherein the adjusted luminance level is a set percentage higher than the reference luminance level.

14. The device of claim 10, wherein the luminance level adjustment logic is configured to adjust the luminance level of the cursor by increasing the luminance level of the cursor to the adjusted luminance level in response to a first triggering event.

15. The device of claim 14, wherein the luminance level adjust logic is further configured to:
decrease the luminance level of the cursor from the adjusted luminance level to a second adjusted luminance level in response to a second triggering event; and
cause display of the cursor at the second adjusted luminance level on the HDR display device.

16. The device of claim 15, wherein the first triggering event is a first user command indicating a request to locate the cursor on the HDR display device, and wherein the second triggering event is a second user command indicating a request to stop locating the cursor on the HDR display device.

17. The device of claim 10, further comprising:
an input/output device configured to provide an activation of a triggering key,
wherein the luminance level adjustment logic is further configured to:
assign the triggering key on the input/output device,
adjust the luminance level associated with the cursor on the HDR display device in response to detecting the activation of the triggering key.

18. The device of claim 10, further comprising:
a pointing device configured to provide user input, and
wherein the luminance level adjustment logic is configured to adjust the luminance level associated with the cursor on the HDR display device in response to detecting the user input from the pointing device.

19. A non-transitory computer readable storage medium comprising executable instructions that when executed by logic causes the logic to:
obtain a reference luminance level indicating a default white value for a high definition range (HDR) display device wherein the reference luminance level is less than a peak luminance level for the HDR display device;
adjust a luminance level of a cursor on the HDR display device to be greater than the reference luminance level; and
cause display of the cursor at the adjusted luminance level on the HDR display device.

20. The non-transitory computer readable storage medium of claim 19, wherein the adjusted luminance level is less than the peak luminance level.
